(19) United States
(12) Patent Application Publication
(10) Pub. No.: US 2026/0252482 A1
(43) Pub. Date: Aug. 27, 2026

(54) CONTROLLER CIRCUIT AND METHOD USED IN CONTROLLER CIRCUIT FOR PERFORMING REMAPPING INDEX SETTING WITHOUT INTERRUPTING CPU

(71) Applicant: Realtek Semiconductor Corp., HsinChu (TW)

(72) Inventor: Hsin-Yu Kuo, HsinChu (TW)

(73) Assignee: Realtek Semiconductor Corp., HsinChu (TW)

(21) Appl. No.: 19/455,768

(22) Filed: Jan. 21, 2026

(30) Foreign Application Priority Data
Feb. 21, 2025 (TW) 114106545

(51) Int. Cl. G06F 12/02; G06F 12/1081

(52) U.S. Cl. CPC G06F 12/0246; G06F 12/1081

(57) ABSTRACT

A method used in controller circuit includes: using register circuit to store setting signal sent from CPU; using remapping index configuration register to store remapping index configuration value; referring to the setting signal to perform multiple consecutive direct memory access operations to access system memory; and, referring to at least one setting data in the setting signal to perform at least one specific direct memory access operation to access the system memory, to update the remapping index configuration value stored by the remapping index configuration register so as to perform a remapping index setting operation.

### BACKGROUND OF THE INVENTION

### 1. Field of the Invention

The present invention relates to a controller mechanism, and more particularly to a controller circuit and a corresponding method.

### 2. Description of the Related Art

Generally speaking, the conventional existing direct memory access (DMA) hardware technology may allow external hardware circuits to access and transfer data directly with a system memory without relying on or occupying resources of a central processing unit (CPU). By using the DMA hardware technology for data transfers, the efficiency of data transmission can be improved, and the burden on the CPU can be reduced to allow the CPU to handle higher-priority tasks.

However, when a large amount of data with non-contiguous addresses needs to be transferred (especially when physical memory remapping is involved), the currently developed technologies require the CPU to configure the remapping index configuration register during the data transfer and access process. As a result, it is not possible to rely solely on the DMA hardware technology to complete the data transfer.

### SUMMARY OF THE INVENTION

Therefore one of the objectives of the present invention is to provide a controller circuit and a method to solve the prior art problems.

According to the embodiments, a controller circuit is disclosed. The controller circuit is coupled to a central processing unit, a system memory, and a remapping index configuration register. The remapping index configuration register is used to store a remapping index configuration value which is used for remapping a virtual address into multiple physical addresses. The controller circuit comprises a register circuit and a processing circuit. The register circuit is configured to store a setting signal sent from the central processing unit, and the setting signal includes multiple setting data and the multiple setting data respectively correspond to multiple consecutive direct memory access operations. The processing circuit is coupled to the register circuit, and is configured to refer to the multiple setting data to perform the multiple consecutive direct memory access operations to access the system memory. The processing circuit is used to refer to at least one specific setting data in the multiple setting data to perform at least one specific direct memory access operation to access the system memory, to update the remapping index configuration value stored in the remapping index configuration register to perform a remapping index setting operation.

According to the embodiments, a method used in a controller circuit is disclosed. The controller circuit is coupled to a central processing unit, a system memory, and a remapping index configuration register. The method comprises: using a register circuit to store a setting signal sent from the central processing unit, the setting signal including multiple setting data, the multiple setting data respectively corresponding to multiple consecutive direct memory access operations; using the remapping index configuration register to store a remapping index configuration value, the remapping index configuration value being used for remapping a virtual address into multiple physical addresses; referring to the multiple setting data to perform the multiple consecutive direct memory access operations to access the system memory; and, referring to at least one specific setting data in the multiple setting data to perform at least one specific direct memory access operation to access the system memory, to update the remapping index configuration value stored in the remapping index configuration register to perform a remapping index setting operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an electronic device according to an embodiment of the present invention.

FIG. 2 is a flowchart diagram which illustrates a method as shown in FIG. 1 for configuring/setting the remapping index configuration register by using a linear descriptor-based DMA mode according to one embodiment of the present invention.

FIG. 3 is a schematic diagram of a descriptor matrix used by the controller circuit shown in FIG. 1 for data access and transfer during DMA operations according to an embodiment of the present invention.

FIG. 4 is a schematic diagram showing the data access and transfer operations performed by using DMA descriptors D1, D2, and D3 as shown in FIG. 3 according to an embodiment of the present invention.

FIG. 5 is a schematic diagram illustrating an example of memory address remapping according to an embodiment of the present invention.

FIG. 6 is a schematic diagram illustrating an example of the CPU configuring the setting of the remapping index configuration register by using the linear descriptor-based DMA technique according to an embodiment of the present invention.

FIG. 7 is a schematic diagram illustrating an example of a descriptor matrix composed of multiple DMA descriptors generated and arranged by the 105 according to an embodiment of the present invention.

FIG. 8 is a schematic diagram illustrating an example of data access, transfer, and the remapping index configuration performed by the controller circuit by using the DMA descriptors D1, MP0, D2, MP1, and D3 (as shown in FIG. 7) according to an embodiment of the present invention.

FIG. 9 is a schematic diagram of a comparison between the performance of an embodiment of the present invention with that of the prior art.

### DETAILED DESCRIPTION

The present invention aims at providing a method and a device for setting a configuration value of a remapping index configuration register by using a linear descriptor-based direct memory access (DMA) mode, to avoid interrupting the operations of the central processing unit (CPU), thereby reducing the CPU’s workload and making the CPU handle higher-priority task(s). The method disclosed in this invention allows users to perform data transfers involving non-contiguous addresses based on hardware techniques that support linear descriptor-based DMA mode. Even when there is a need to configure a remapping index configuration register, this can be achieved without CPU intervention, thus mitigating the workload of the CPU and allowing the CPU to handle and process more critical task(s). In other words, this does not need to interrupt the CPU’s operations. More specifically, the actions of configuring the remapping index configuration register can be encapsulated as a direct memory access descriptor, so that the configuration of the remapping index configuration register is effectively carried out as a part of a direct memory access data transfer operation, thereby achieving the address remapping.

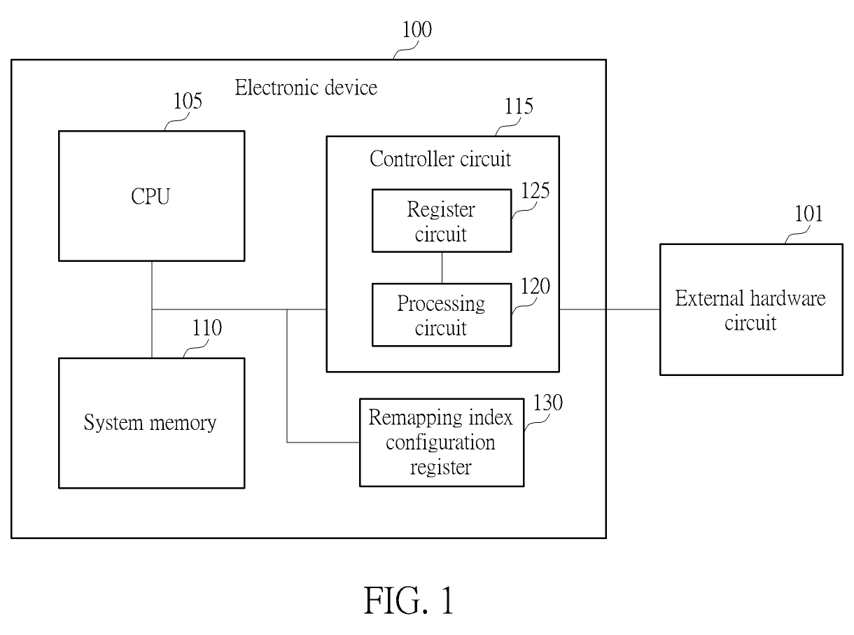

Refer to FIG. 1. FIG. 1 is a block diagram of an electronic device 100 according to an embodiment of the present invention. The electronic device 100 includes a central processing unit (CPU) 105, a system memory 110, a controller circuit 115, and a remapping index configuration register 130. The electronic device 100 may be for example externally coupled to an external hardware circuit 101. The controller circuit 115 for example is a direct memory access (DMA) controller which is positioned between the CPU 105 and the external hardware circuit 101. The controller circuit 115 is configured to receive the settings from the CPU 105 to perform a DMA operation to perform direct data movement and transfer without relying on (or consuming) the CPU's 105 resources, to move and transfer data stored in the system memory 110 directly to the external hardware circuit 101. The controller circuit 115 is externally coupled to the CPU 105, system memory 110, and remapping index configuration register 130, and it comprises a processing circuit 120 and a register circuit 125.

The register circuit 125 is used to store a setting signal sent from the CPU 105. The setting signal includes multiple setting data which respectively correspond to multiple consecutive DMA operations. These setting data for example may be multiple DMA descriptors under a linear descriptor-based DMA mode. The remapping index configuration register 130 is used to store a remapping index configuration value which is used to remap a virtual address into multiple physical addresses.

The processing circuit 120 is coupled to the register circuit 125 and it is configured to refer to the multiple setting data (i.e. the multiple DMA descriptors) to perform the multiple consecutive DMA operations to access the system memory 110. The processing circuit 120 refers to at least one specific setting data (e.g. at least one DMA descriptor corresponding to the remapping index configuration) to execute at least one specific DMA operation to access the system memory 110, to update the remapping index configuration value stored in the remapping index configuration register 130 and to perform a remapping index setting operation.

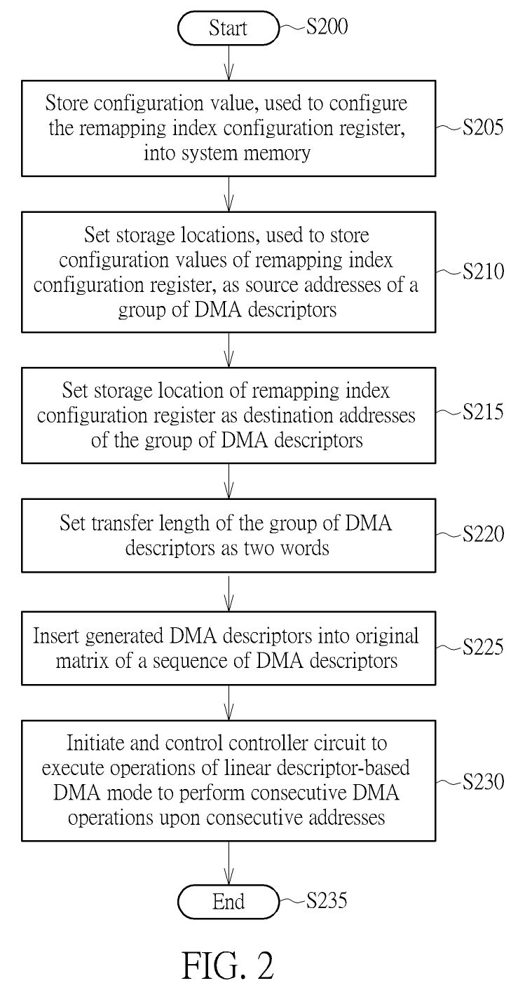

Please refer to FIG. 2. FIG. 2 is a flowchart diagram which illustrates a method as shown in FIG. 1 for configuring/setting the remapping index configuration register by using a linear descriptor-based DMA mode according to one embodiment of the present invention. As shown in FIG. 2, the steps of the method are as follows:

Step S200: Start;

Step S205: The CPU 105 stores a configuration value, which is used to configure the remapping index configuration register 130, into the system memory 110; the configuration value is used to indicate different remapping storage regions;

Step S210: The CPU 105 sets the storage locations (e.g. 0x8003_0000 and 0x8003_0004), which are used to store and place the configuration values of the remapping index configuration register 130, as source addresses of a group of DMA descriptors;

Step S215: The CPU 105 sets the storage location of the remapping index configuration register 130 (e.g. 0x8002_0000) as the destination addresses of the group of DMA descriptors;

Step S220: The CPU 105 sets the transfer length of the group of DMA descriptors as for example two words which are equal four bytes which equal to 32 bits; however, this is not a limitation of the invention; in different embodiments, the transfer length may correspondingly vary depending on a different address length;

Step S225: The CPU 105 inserts the generated and encapsulated DMA descriptors into an original matrix of a sequence of DMA descriptors (i.e. a descriptor matrix);

Step S230: The CPU 105 configures the initial register (i.e. the register circuit 125) for linear descriptor-based DMA mode to initiate and control the processing circuit 120 of the controller circuit 115 to execute the operations of the linear descriptor-based DMA mode so as to perform consecutive DMA operations upon consecutive addresses, and the consecutive DMA operations includes the operation to configure the remapping index configuration register; and

Step S235: End.

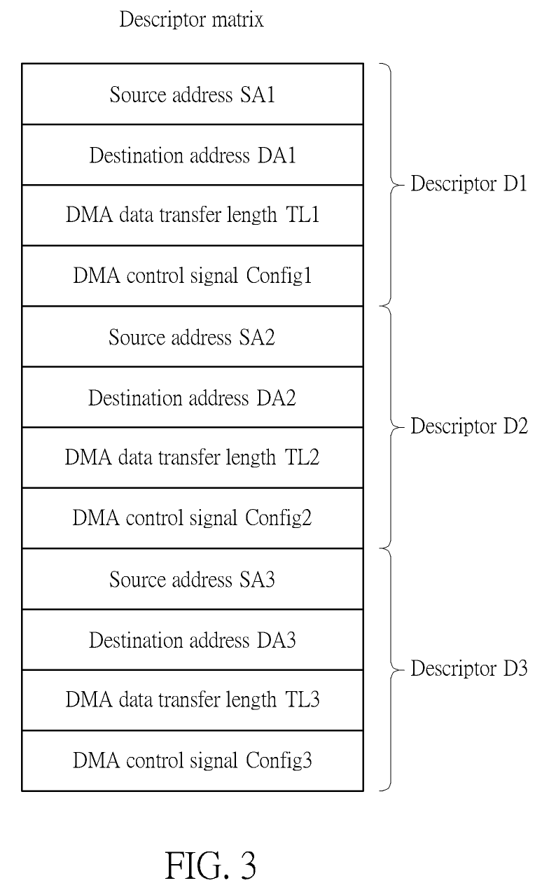

FIG. 3 is a schematic diagram of a descriptor matrix used by the controller circuit 115 shown in FIG. 1 for data access and transfer during DMA operations according to an embodiment of the present invention. The operation of linear descriptor-based DMA mode utilized by the controller circuit 115 is an advanced DMA operation. When a large amount of data with non-contiguous addresses needs to be transferred, the CPU 105 can prearrange a series of DMA descriptors, i.e. forming a DMA descriptor matrix, in which each descriptor includes a source address, a destination address, a transfer data size, and a control signal for the execution of the DMA operation for one time to access and transfer data. The source address specifies the starting address of the data to be moved in that DMA operation. The destination address specifies an address into which the data should be written after being moved and transferred. The transfer data size indicates the amount of data to be transferred for that DMA operation. The control signal indicates other control settings necessary for executing that DMA operation. When a DMA descriptor is received, the controller circuit 115 can execute a corresponding DMA operation based on the source address, destination address, transfer data size, and the control signal included in the received descriptor.

For example, as shown in FIG. 3, the CPU 105 may pre-generate and arrange/encapsulate multiple DMA descriptors D1, D2, and D3, which are sequentially organized to form an array (or matrix) in the order of D1, D2, and D3. The DMA descriptor D1 includes a source address SA1, a destination address DA1, a transfer length TL1, and a control signal Config1. The DMA descriptor D2 includes a source address SA2, a destination address DA2, a transfer length TL2, and a control signal Config2. The DMA descriptor D3 includes a source address SA3, a destination address DA3, a transfer length TL3, and a control signal Config3.

By configuring the register circuit 125, the CPU 105 can sequentially store the DMA descriptors D1, D2, and D3 in the register circuit 125, and then can trigger/activate the controller circuit 115 to refer to the information of the stored DMA descriptors D1, D2, and D3 to execute a series of consecutive DMA operations. In this way, after completing the data moving and transfer of one DMA operation described by a descriptor, the controller circuit 115 can automatically proceed to execute the DMA operation of the data moving and transfer specified by a next DMA descriptor. During the period of data transfer of these non-contiguous addresses, the CPU 105 can handle higher-priority task(s) or can enter a power-saving mode.

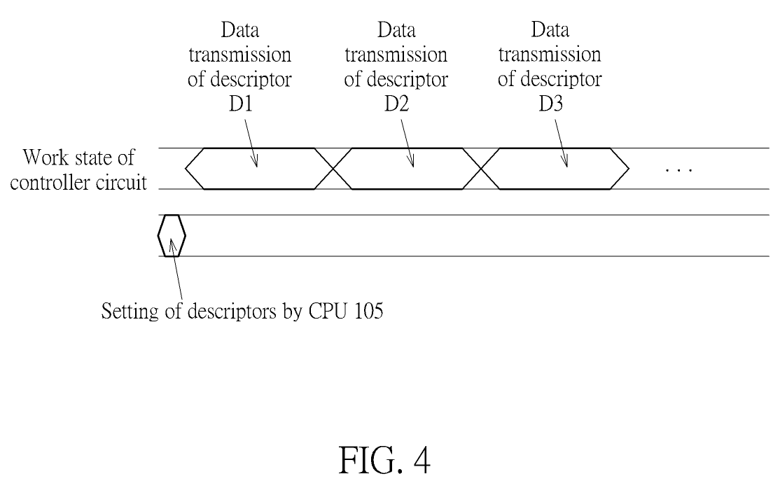

FIG. 4 is a schematic diagram showing the data access and transfer operations performed by using DMA descriptors D1, D2, and D3 as shown in FIG. 3 according to an embodiment of the present invention. As shown in FIG. 4, after the CPU 105 configures the register circuit 125 to sequentially store the DMA descriptors D1, D2, and D3 in the register circuit 125, the controller circuit 115 can handle/execute the subsequent data access and transfer (i.e., the data transmissions of the DMA descriptors D1, D2, and D3), and the CPU 105 can be an idle state or enter a power saving mode.

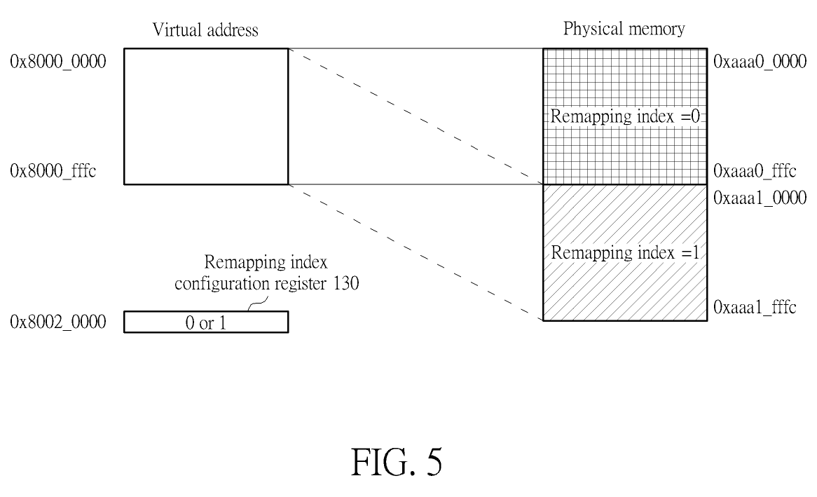

FIG. 5 is a schematic diagram illustrating an example of memory address remapping according to an embodiment of the present invention. As shown in FIG. 5, the memory remapping technique enables access to a larger physical memory space by remapping limited virtual addresses into different physical memory regions. In practice, a single remapping index configuration register (e.g. remapping index configuration register 130) can be used to specify which physical memory region a virtual address should map to. For example, if the content value in the remapping index configuration register 130 is set as 0, then the virtual addresses from 0x8000_0000 to 0x8000_fffc will be mapped into the storage locations of the physical memory addresses from 0xaaa0_0000 to 0xaaa0_fffc. In this situation, the operation of data moving and transfer by using the virtual addresses from 0x8000_0000 to 0x8000_fffc is performed to access data of the storage locations of the physical memory addresses from 0xaaa0_0000 to 0xaaa0_fffc. Instead, if the content value in the remapping index configuration register 130 is set as 1, then the same virtual addresses from 0x8000_0000 to 0x8000_fffc will be mapped into the storage locations of the different physical memory addresses from 0xaaa1_0000 to 0xaaa1_fffc. In this situation, the operation of data moving and transfer by using the virtual addresses from 0x8000_0000 to 0x8000_fffc is performed to access data of the storage locations of the physical memory addresses from 0xaaa1_0000 to 0xaaa1_fffc. Thus, by using memory remapping, the same virtual addresses from 0x8000_0000 to 0x8000_fffc can be used to respectively access data of the storage locations of the different physical memory addresses from 0xaaa1_0000 to 0xaaa1_fffc. The storage address of the remapping index configuration register 130 for example can be implemented to correspond to a virtual address such as 0x8002_0000; however, this is not intended to be a limitation of the invention.

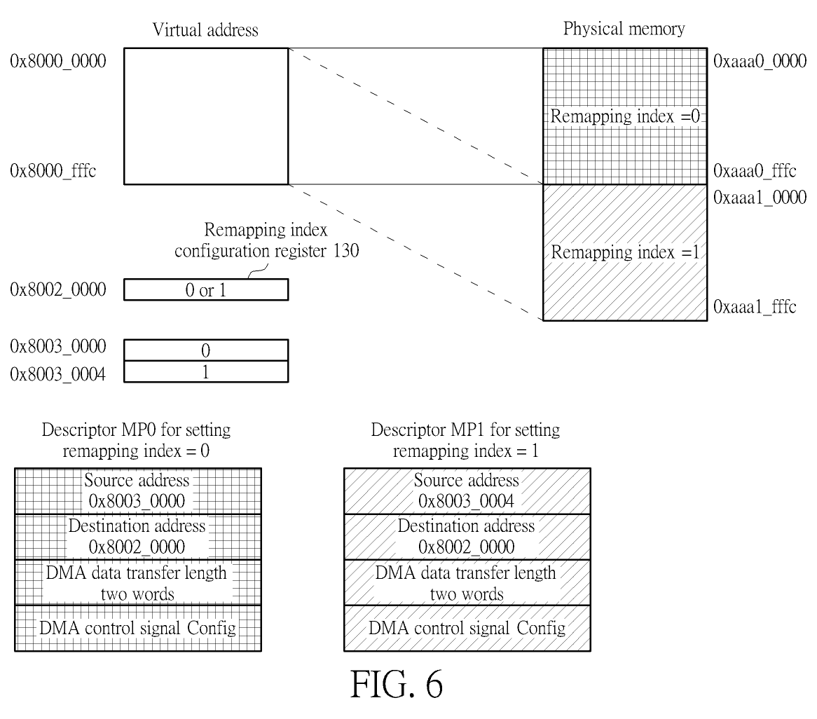

FIG. 6 is a schematic diagram illustrating an example of the CPU 105 configuring the setting of the remapping index configuration register by using the linear descriptor-based DMA technique according to an embodiment of the present invention. Please refer to FIG. 1, FIG. 2, and FIG. 6. According to the step S205 of FIG. 2, as shown in FIG. 6, when performing the configuration, the CPU 105 stores at least one configuration value of the remapping index configuration register 130 into the storage location of at least one physical memory address in the system memory 110. For example, the CPU 105 stores a value ‘0’ (i.e. a bit value ‘0’) into a physical memory storage location in the system memory 110 (e.g. the physical memory storage location corresponds to a virtual address 0x8003_0000), and it stores another value ‘1’ (i.e. a bit value ‘1’) into another physical memory storage location (e.g. the physical memory storage location corresponds to another virtual address 0x8003_0004). Additionally, the remapping index configuration register 130 is used to store the information of the storage location of its configuration value, e.g. a physical memory storage location corresponding to a virtual address such as 0x8002_0000.

Then, according to step S210, step S215, and step S220 of FIG. 2, as shown in FIG. 6, the CPU 105 is used to configure the contents of the multiple source addresses of a group of two DMA descriptors MP0 and MP1 as the storage locations which are used to store the configuration values ‘0’ and ‘1’ (i.e. respectively corresponding to virtual addresses 0x8003_0000 and 0x8003_0004) of the remapping index configuration register 130. Then, the CPU 105 sets the destination addresses of the group of two DMA descriptors MP0 and MP1 as the storage location (e.g. 0x8002_0000) of the remapping index configuration register 130, i.e. the destination addresses of the group of two DMA descriptors MP0 and MP1 are for example equal to the same virtual address 0x8002_0000. Next, the CPU 105 sets the transfer length of the group of two DMA descriptors MP0 and MP1 as for example two words which equal to four bytes or 32 bits. Then, the CPU 105 sets the control signals of the group of two DMA descriptors MP0 and MP1 as the same DMA control signal Config or as different DMA control signals.

Accordingly, based on the DMA descriptor MP0, the processing circuit 120 can perform a DMA operation for one time by using the source address 0x8003_0000, the destination address 0x8002_0000, a transfer length of two words, and the control signal Config. The processing circuit 120 can move and transfer a data unit having the first word size from the first storage location (corresponding to the source address 0x8003_0000) in the system memory 110 into the second storage location (corresponding to the destination address 0x8002_0000) in the system memory 110 to update the content value stored by the remapping index configuration register 130. In addition, based on the DMA descriptor MP1, the processing circuit 120 can perform another DMA operation for one time by using the source address 0x8003_0004, destination address 0x8002_0000, the same transfer length (two words), and the control signal (i.e. DMA control signal Config). The processing circuit 120 moves and transfers a second data unit having two words from a third storage location (corresponding to the source address 0x8003_0004) in the system memory 110 into the second storage location (corresponding to the destination address 0x8002_0000) in the system memory 110, to update the content value stored by the remapping index configuration register 130.

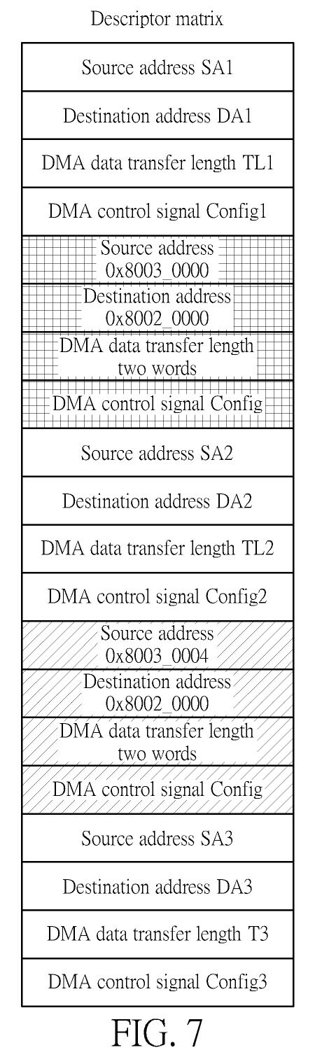

FIG. 7 is a schematic diagram illustrating an example of a descriptor matrix composed of multiple DMA descriptors generated and arranged by the CPU 105 according to an embodiment of the present invention. As shown in FIG. 7, according to Step S225 of FIG. 2, the CPU 105 inserts the generated and arranged DMA descriptors MP0 and MP1 into the sequence of DMA descriptors D1, D2, D3 (as shown in FIG. 3) to form a new descriptor matrix. For example, the CPU 105 inserts the generated DMA descriptor MP0 into a location between descriptors D1 and D2, and insert the generated DMA descriptor MP1 into a location between descriptors D2 and D3, as shown in FIG. 3.

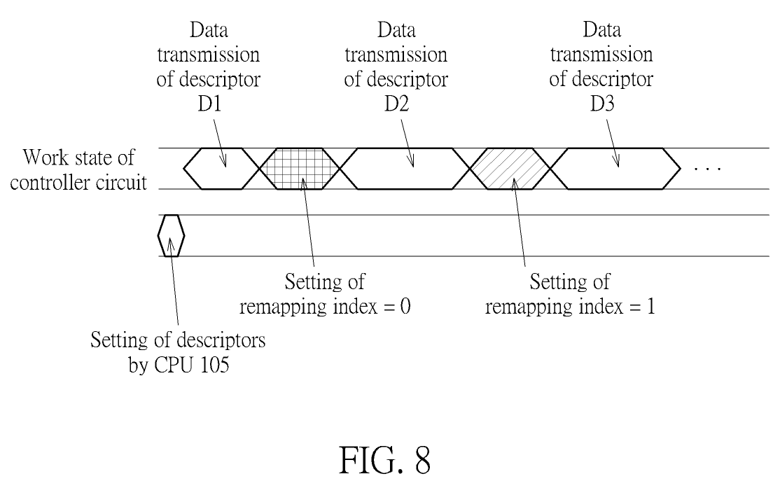

FIG. 8 is a schematic diagram illustrating an example of data access, transfer, and the remapping index configuration performed by the controller circuit 115 by using the DMA descriptors D1, MP0, D2, MP1, and D3 (as shown in FIG. 7) according to an embodiment of the present invention. As shown in FIG. 8, in accordance with Step S230 of FIG. 2, after the CPU 105 sets the data of DMA descriptor data (D1, MP0, D2, MP1, and D3 as shown in FIG. 7) into the register circuit 125 of the controller circuit 115, the processing circuit 120 (e.g., a DMA hardware engine) within the controller circuit 115 is activated to perform consecutive DMA operations. After the CPU 105 has performed the setting of the DMA descriptors as shown in FIG. 7, the processing circuit 120 of the controller circuit 115 can refer to the information stored in register circuit 125 to perform the data access and transfer of DMA descriptor D1. The processing circuit 120 then may perform the setting operation of the remapping index being equal to 0 (i.e. to move, transfer, and write a data word ‘0’ corresponding to the source address 0x8003_0000 into the destination address 0x8002_0000) to update the configuration value of the remapping index configuration register 130. The processing circuit 120 then may perform the data access and transfer of the DMA descriptor D2. The processing circuit 120 then may perform the setting operation of the remapping index being equal to 1 (i.e. to move, transfer, and write a data word ‘1’ corresponding to the source address 0x8003_0004 into the destination address 0x8002_0000) to update the configuration value of the remapping index configuration register 130. The processing circuit 120 then may perform the data access and transfer of the DMA descriptor D3. During the above-mentioned consecutive DMA operations, it is not needed to interrupt the operations of CPU 105 for performing the remapping index setting operation. The processing circuit 120 within the controller circuit 115 can equivalently perform and update the remapping index setting by merely performing corresponding DMA operations, without involving the operations of CPU 105. This can reduce the workload of the CPU 105.

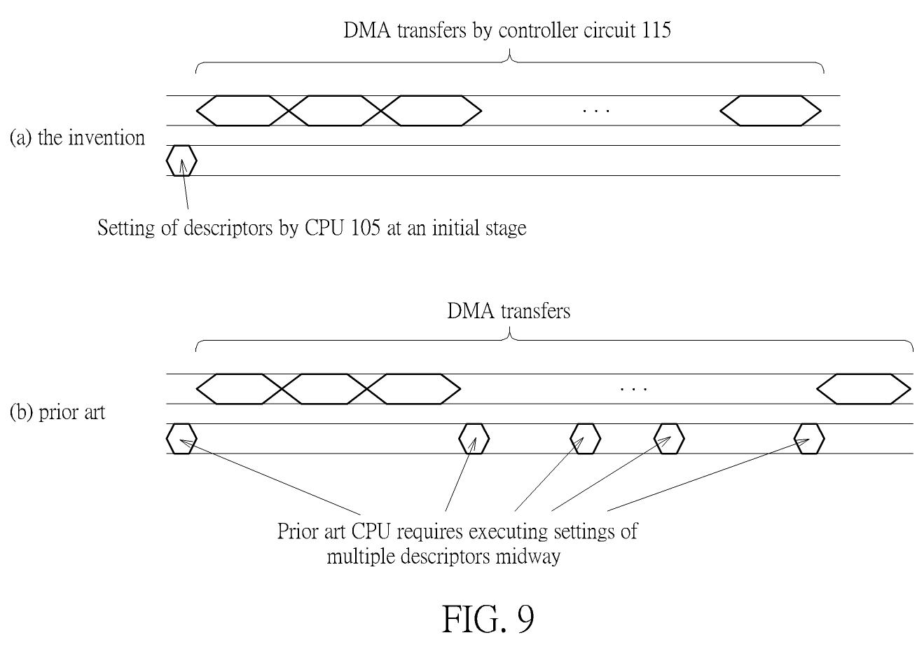

FIG. 9 is a schematic diagram of a comparison between the performance of an embodiment of the present invention with that of the prior art. For instance, in a scenario involving using 98 DMA descriptors to transfer 27KB of data with four remapping index configurations, as shown in the top portion (a) of FIG. 9, according to an embodiment of the invention, after the CPU 105 configures the data of the 98 DMA descriptors into the register circuit 125 of the controller circuit 115, the processing circuit 120 within the controller circuit 115 can be activated to perform a sequence of consecutive DMA operations, and during the execution of the sequence of consecutive DMA operations the CPU 105 will not be interrupted and thus the resources of CPU 105 will not be occupied. For the processing circuit 120 within the controller circuit 115, it is merely needed to perform the corresponding DMA operations to equivalently perform and update the remapping index setting. In this situation, the time required to execute the DMA operations of the 98 DMA descriptors is approximately 1073 microseconds. In contrast, as shown in the bottom portion (b) of FIG. 9, the prior art requires the CPU to directly handle the four remapping index settings. Thus, during the DMA data transfer process, the prior art CPU must be interrupted for multiple times to perform the tasks of remapping index setting operation. Even if the prior art CPU is in a low-power state, during the DMA data transfer the prior art CPU must be forced to exit the low-power state to use prior art CPU’s resources to perform the remapping index setting operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller circuit, coupled to a central processing unit, a system memory, and a remapping index configuration register, the remapping index configuration register being used to store a remapping index configuration value which is used for remapping a virtual address into multiple physical addresses, and the controller circuit comprises:
a register circuit, configured to store a setting signal sent from the central processing unit, the setting signal including multiple setting data, the multiple setting data respectively corresponding to multiple consecutive direct memory access operations; and
a processing circuit, coupled to the register circuit, configured to refer to the multiple setting data to perform the multiple consecutive direct memory access operations to access the system memory;
wherein the processing circuit is used to refer to at least one specific setting data in the multiple setting data to perform at least one specific direct memory access operation to access the system memory, to update the remapping index configuration value stored in the remapping index configuration register to perform a remapping index setting operation.

2. The controller circuit of claim 1, wherein the at least one setting data comprises a first direct memory access descriptor which comprises a first source address, a first destination address, a first transfer length, and a first control signal; the first source address corresponds to a first storage location in the system memory, and the first storage location is used to store a first remapping index configuration value; the first destination address corresponds to a second storage location in the system memory, and the second storage location is used to indicate a storage location of the remapping index configuration register; the first transfer length indicates a first word size, and the first control signal is used to indicate a first direct memory access control setting.

3. The controller circuit of claim 2, wherein the processing circuit performs a direct memory access operation for one time based on the first source address, the first destination address, the first transfer length, and the first control signal, to move and transfer a data unit having the first word size from the first storage location in the system memory into the second storage location in the system memory to update a content stored in the remapping index configuration register.

4. The controller circuit of claim 2, wherein the at least one setting data further comprises a second direct memory access descriptor which comprises a second source address, a second destination address, a second transfer length, and a second control signal; the second source address corresponds to a third storage location in the system memory, and the third storage location is used to store a second remapping index configuration value; the second destination address corresponds to the second storage location in the system memory and is used to indicate the storage location of the remapping index configuration register; the second transfer length indicates a second word size, and the second control signal indicates a second direct memory access control setting.

5. The controller circuit of claim 4, wherein the processing circuit performs a direct memory access operation for one time based on the second source address, the second destination address, the second transfer length, and the second control signal, to move and transfer a data unit having the second word size from the third storage location in the system memory into the second storage location in the system memory to update a content stored in the remapping index configuration register.

6. A method used in a controller circuit, the controller circuit being coupled to a central processing unit, a system memory, and a remapping index configuration register, and the method comprises:
using a register circuit to store a setting signal sent from the central processing unit, the setting signal including multiple setting data, the multiple setting data respectively corresponding to multiple consecutive direct memory access operations;
using the remapping index configuration register to store a remapping index configuration value, the remapping index configuration value being used for remapping a virtual address into multiple physical addresses;
referring to the multiple setting data to perform the multiple consecutive direct memory access operations to access the system memory; and
referring to at least one specific setting data in the multiple setting data to perform at least one specific direct memory access operation to access the system memory, to update the remapping index configuration value stored in the remapping index configuration register to perform a remapping index setting operation.

7. The method of claim 6, wherein the at least one setting data comprises a first direct memory access descriptor which comprises a first source address, a first destination address, a first transfer length, and a first control signal; the first source address corresponds to a first storage location in the system memory, and the first storage location is used to store a first remapping index configuration value; the first destination address corresponds to a second storage location in the system memory, and the second storage location is used to indicate a storage location of the remapping index configuration register; the first transfer length indicates a first word size, and the first control signal is used to indicate a first direct memory access control setting.

8. The method of claim 7, further comprising:
performing a direct memory access operation for one time based on the first source address, the first destination address, the first transfer length, and the first control signal, to move and transfer a data unit having the first word size from the first storage location in the system memory into the second storage location in the system memory to update a content stored in the remapping index configuration register.

9. The method of claim 7, wherein the at least one setting data further comprises a second direct memory access descriptor which comprises a second source address, a second destination address, a second transfer length, and a second control signal; the second source address corresponds to a third storage location in the system memory, and the third storage location is used to store a second remapping index configuration value; the second destination address corresponds to the second storage location in the system memory and is used to indicate the storage location of the remapping index configuration register; the second transfer length indicates a second word size, and the second control signal indicates a second direct memory access control setting.

10. The method of claim 9, further comprising:
performing a direct memory access operation for one time based on the second source address, the second destination address, the second transfer length, and the second control signal, to move and transfer a data unit having the second word size from the third storage location in the system memory into the second storage location in the system memory to update a content stored in the remapping index configuration register.
